(19) United States
(12) Patent Application Publication
(10) Pub. No.: US 2019/0020249 A1
(43) Pub. Date: Jan. 17, 2019

(54) ASSEMBLY PROCEDURE FOR A LONG-STATOR LINEAR MOTOR

(71) Applicant: B&R INDUSTRIAL AUTOMATION GMBH, Eggelsberg (AT)

(72) Inventors: Michael REINTHALER, Pfaffstaett (AT); Goran STOJCIC, Anthering (AT)

(73) Assignee: B&R INDUSTRIAL AUTOMATION GMBH, Eggelsberg (AT)

(21) Appl. No.: 16/032,807

(22) Filed: Jul. 11, 2018

(30) Foreign Application Priority Data
Jul. 12, 2017 (AT) A50577/2017

(51) Int. Cl. H02K 15/00; H02K 5/22; H02K 41/02

(52) U.S. Cl. CPC H02K 15/0068; H02K 41/02; H02K 5/225

(57) ABSTRACT

Procedure mounting at least one power electronic unit of a transport segment of a long-stator linear motor onto the transport segment. At least one socket is arranged on the transport segment to accommodate at least one contact element of the drive coil arranged in the socket. At least one clamping element is inserted into the socket with a clamping section. The contact element of the drive coil, while creating an electroconductive connection to the clamping section of the clamping element, is fixed into the socket by the clamping element. At least one contact point of the at least one power electronic unit, while creating an electroconductive connection, is connected directly to a connecting section of the clamping element. The contact element is first arranged in the socket, then the clamping element is inserted into the socket, and then the contact point is connected directly to the connecting section.

### CROSS-REFERENCE TO RELATED APPLICATIONS

The present application claims priority under 35 U.S.C. § 119(a) of Austria Patent Application No. A50577/2017 filed Jul. 12, 2017, the disclosure of which is expressly incorporated by reference herein in its entirety.

### BACKGROUND OF THE INVENTION

### 1. Field of the Invention

The invention relates to an assembly procedure for connecting at least one power electronic unit to a transport segment of a long-stator linear motor, wherein the transport segment comprises at least one drive coil with at least two contact elements and the at least one power electronic unit comprises at least two contact points that correspond to the contact elements of the drive coil, wherein an electroconductive connection between the contact elements of the drive coil and the contact points of the at least one power electronic unit is created.

### 2. Discussion of Background Information

In one sufficiently known long-stator linear motor, a plurality of electrical drive coils, which form the stator, are stationed along a transport path. Arranged on a transport unit are a number of drive magnets, either as permanent magnets or as an electric coil or short-circuit winding, which interact with the drive coils. The interaction of the (electro)magnetic fields of the drive magnets and the drive coils creates a propelling force onto the transport unit, which moves the transport unit forwards. The long-stator linear motor can be configured as a self-excited or externally excited synchronous machine, or as an asynchronous machine. Controlling the individual drive coils through the application of coil voltages for regulating the magnetic flow influences the magnitude of the propelling force, and the transport unit can be moved along the transport path in the desired manner.

Often the long stator or a transport path is also built in the form of individual path sections, which in turn consist of assembled transport segments. As a result of this modularity, a long-stator linear motor can be simpler to build, in particular if defined path sections and transport segments are used. The constructional design of the long-stator linear motor, i.e., for example, the design of the drive coils, the conveying path, the transport units, the guides of the transport unit, etc., can of course be different, but the basic functional principle of a long-stator linear motor remains the same.

Examples of such long-stator linear motors can be found in WO 2013/143783 A1, U.S. Pat. No. 6,876,107 B2, US 2013/0074724 A1 or WO 2004/103792 A1.

The drive coils are typically arranged on the transport path or on a transport segment in a longitudinal direction at a distance from one another by means of a so-called “groove pattern.” To generate a propelling force onto the transport unit, a coil voltage is generally applied to the individual drive coils, whose parameters (e.g., amount and duration of the voltage) are generally continuously set by a control unit in accordance with the desired movement of the transport unit (position, speed, acceleration) during the operation of the transport device. At the same time, the voltage is supplied by means of a power electronic unit, which normally is arranged on the transport path or on a transport segment in the form of a circuit board. At the same time, the power electronic unit generally has a number of contact points that correspond to the number of drive coils of the transport segment, so that an electroconductive connection can be created between the drive coils and the power electronic unit. As a result of the large number of drive coils that are arranged on a transport segment at a relatively small distance from one another, high demands are of course also placed on the manufacturing process and the assembly, especially of a transport segment. In order to simplify and accelerated production, it is advantageous to electroconductively connect all drive coils to the power electronic unit or circuit board at the same time, i.e. in one work step. To that end, the wires of the individual drive coils are, for example, attached and soldered to the corresponding contact points of the circuit board, which, however, because of the narrow space available, requires a very complex process control, which is disadvantageous. Alternatively, screw terminals can be arranged on the circuit board, into which the wires of the drive coils can be inserted, whereupon the screws of the screw terminals are tightened. Due to the generally very large number of drive coils and the narrow spatial conditions, it is not possible to tighten all screw connections at the same time, or only with a lot of effort. Although a sequential tightening of the screw connections would be possible, this would prolong the assembly time, which is disadvantageous. Moreover, both the screwing and the soldering of the wires of the drive coils onto the circuit board requires stripping off the insulation of the wires of the drive coils, which are typically enameled wires, beforehand, which is very expensive and time-consuming and therefore disadvantageous.

WO 2016/008827 A2, EP 1 909 362 A1, DE 199 24 323 A1, DE 10 2012 106 471 A1 and EP 3 236 564 A1 describe rotary electric motors in various configurations, each with circuit boards electrically connected to coil windings. However, in a long-stator linear motor, there are generally significantly more drive coils connected to a circuit board than is the case with rotary electric motors. Thus, the prior art does not describe any satisfactory solutions that guarantee that no impermissibly high forces will be applied to the circuit board during the assembly of transport segments of a long-stator linear motor.

### SUMMARY OF THE EMBODIMENTS

Accordingly, it is an aim of the invention to create a simple and quick assembly procedure for assembling on the transport segment a power electronic unit of a transport segment of a long-stator linear motor, with the lowest possible stress placed on the power electronic unit during assembly.

According to the invention, the problem is solved by arranging on the transport segment at least one socket for accommodating at least one contact element of the drive coil, arranging the at least one contact element of the drive coil in the socket, inserting at least one clamping element corresponding to the socket into the socket with a clamping section, wherein the contact element of the drive coil, while creating an electroconductive connection to the clamping section of the clamping element, is fixed in the socket by the clamping element, and that at least one contact point of the power electronic unit, while creating an electroconductive connection, is directly connected to a connecting section of the clamping element, wherein first the contact element of the drive coil is arranged in the socket, then the clamping element is inserted into the socket with the clamping section and then the contact point of the power electronic unit is connected directly to the connecting section of the clamping element by means of soldering or plugging. As a result, first the clamping element is attached using a mounting force necessary to clamp it down and then the power electronic unit is attached to the clamping element, which relieves the pressure on the power electronic unit.

However, it is advantageous if at least two sockets for accommodating at least one contact element each are arranged on the transport segment, wherein the at least two contact elements are arranged in the sockets, wherein at least two clamping elements corresponding to the sockets, each with a clamping section, are inserted into the sockets sequentially or simultaneously, and wherein at least two contact points of the at least one power electronic unit are connected to the connecting sections of the clamping elements sequentially or simultaneously. This makes it possible to connect one (or more) power electronic unit(s) to several, preferably all, drive coils of a transport segment.

It is advantageous if the at least one contact element of the drive coil is an electroconductive wire with an outer insulating layer, a so-called “enameled” wire, and the at least one clamping element is a cutting and clamping element with a cutting and clamping section, wherein when the cutting and clamping element is inserted into the at least one socket the outer insulating layer of the contact element of the drive coil is severed by the cutting and clamping section to create the electroconductive connection. As a result, even when an insulated wire is used, it is easy to create an electroconductive connection between the contact elements and the clamping element.

It is preferable if the connecting section of the clamping element is designed as a clip-connection section and the corresponding contact point of the power electronic unit is designed as a clip-contact point, wherein the clip-connection section is inserted to connect the power electronic unit to the clamping element in the clip-contact point of the power electronic unit that corresponds to it by applying a press-in force. This simplifies the assembly and the press-in force can be kept low as a result of the clip connections.

It is advantageous if the at least one contact point of the power electronic unit is executed as an opening with a closed circumferential surface corresponding to the shape of the connecting section of the clamping element that penetrates the power electronic unit, wherein when the power electronic unit is connected to the clamping element, the connecting section at least partially penetrates the opening and is completely enclosed by the closed circumferential surface.

### BRIEF DESCRIPTION OF THE DRAWINGS

The present invention is explained in detail below with reference to FIGS. 1 through 3, which show, for example, nonrestrictive advantageous embodiments of the invention.

FIG. 1 is an exploded view of a preferred embodiment of the invention;

FIGS. 2A and 2B show procedural steps of the use of a cutting and clamping element; and

FIG. 3 is a detailed view of a cutting and clamping element.

### DETAILED DESCRIPTION OF THE EMBODIMENTS

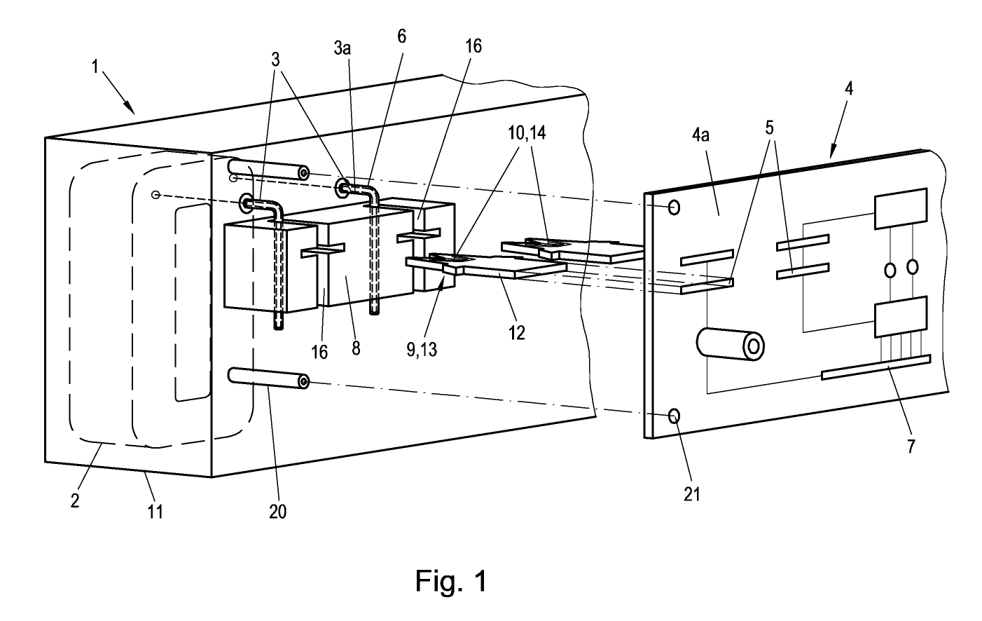

FIG. 1 shows a transport segment 1 of a long-stator linear motor in an exploded view where, as is known, arranged lengthwise on the transport segment 1 apart from one another at a certain distance are a plurality of drive coils 2, the so-called “groove pattern.” For reasons of clarity, however, only one drive coil 2 is indicated in FIG. 1. Generally, the drive coils 2 are arranged in a closed housing 11 of the transport segment 1, wherein the housing 11 is often poured out with a casting compound.

To apply a voltage, the drive coil 2 usually has at least two contact elements 3 that create an electroconductive connection to contact points 5 of a power electronic unit 4. To that end, the contact elements 3 are, if necessary, conveyed out from the housing 11 of the transport segment 1 in order to make contact. The contact elements 3 of the drive coil 2 are preferably executed in the form of electrically insulated wires (especially preferred as enameled wires 3a) that are coated with an insulating layer 6 (made of paint, for example).

The power electronic unit 4 is preferably executed as a conventional printed circuit board 4a, onto which electronic components 7 are arranged (electronic components 7 are not important for the invention and are shown only to better illustrate FIG. 1).

Arranged on transport segment 1 is at least one socket 8 for receiving at least one contact element 3; preferably, the socket 8, as shown in FIG. 1, is executed so that it is suitable for accommodating the two contact elements 3 of a drive coil 2. However, there also could be arranged on the transport segment 1 a separate socket 8 for each contact element 3 but, because of the limited spatial conditions, it is advantageous that the socket 8 can accommodate at least the two contact elements 3 of a drive coil 2. Of course, it would also be conceivable to execute a socket 8 so that several contact elements 3 of adjacent drive coils 2 could be accommodated, which could further reduce the number of individual sockets 8. For example, it is possible to arrange only one socket 8 in the form of a strip along the entire length of the transport segment 1 that is suitable for accommodating all contact elements 3 of all drive coils 2 of the transport segment. The socket 8 is preferably made out of an electrically nonconductive material, such as plastic, for example.

The power electronic unit 4 and the printed circuit board 4a respectively have at least one contact point 5 for creating an electroconductive connection to the drive coil 2, or to the contact elements 3 of the drive coil 2, respectively. Preferably, the number of contact points 5 of the circuit board 4a corresponds to the number of contact elements 3; i.e., for each drive coil 2, for example, two contact points 5 can be arranged on the circuit board 4a. Accordingly, in the case of, for example, 80 drive coils 2 per transport segment 1, 160 contact points 5, for example, would be arranged on the circuit board 4a, which must correspond and be connected to 160 contact elements 3 of the drive coils 2. However, this does not necessarily mean that a single power electronic unit 4 or circuit board 4a must be arranged on the transport segment. For example, a circuit board 4a could also be divided into several circuit board segments, each having a certain number of contact points 5 to connect corresponding contact elements 3 of the drive coils 2.

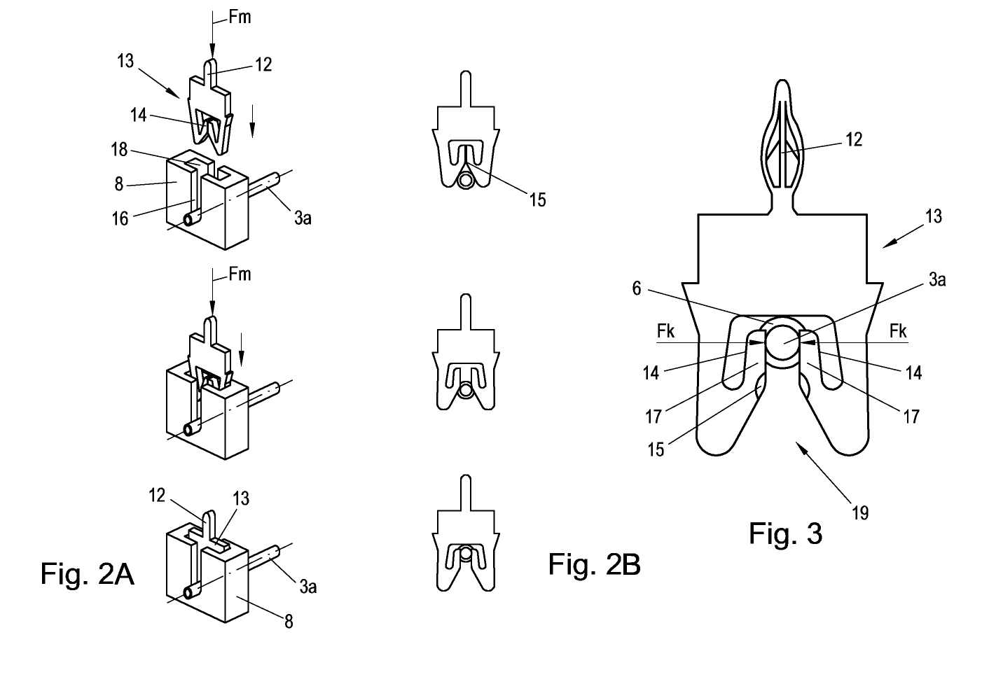

According to the invention, arranged on the transport segment 1 is at least one clamping element 9 that corresponds to the socket 8, which along with a clamping section 10 is inserted into the socket 8 in such a way that the contact element 3 of the drive coil 2, while creating an electroconductive connection, is fixed, along with the clamping section 10 of the clamping element 9, into the socket 8 by the clamping element 9, as is explained in further detail below with reference to FIG. 2.

In the example of FIG. 1, the contact elements 3 are conveyed out from the housing 11 and bent by approximately 90°, so that the free ends of the contact elements 3 are arranged in slots 16 of the socket 8 arranged on the housing 11.

After the clamping element 9 is fixed in the socket 8, at least one contact point 5 of the power electronic unit 4, while creating an electroconductive connection, is connected to a connecting section 12 of the clamping element 9. However, it is preferable that a clamping element 9 is arranged for each contact element 3 of a drive coil 2. This has the advantage that the force to be applied to the clamping elements 9 that is necessary to secure the contact elements 3 into the sockets 8 can be absorbed by a suitable assembly tool, for example. The power electronic unit 4 can then, along with the contact points 5, be arranged on the already attached clamping elements 9 without any or with little physical effort.

However, the contact point 5 of the power electronic unit 4, while creating an electroconductive connection, can first be connected to the connecting section 12 of the clamping element 9 and subsequently the clamping element 9 can be fixed into the socket 8 by making contact with the contact element 3. This procedure can be used in particular in the case of transport segments 1 with only a few drive coils 2. If the power electronic unit 4 can withstand the forces necessary to plug the contact elements 3 into the sockets 8, it would therefore also be conceivable to connect the clamping elements 9 to the power electronic unit 4 sequentially or in one work step, and to insert the entire power electronic unit 4, including the clamping elements 9 arranged on it, simultaneously into the sockets 8 along with the contact elements 3 of the drive coils 2 arranged on them, and to plug in all contact elements 3 simultaneously.

The insertion of the clamping elements 9 into the individual sockets 8 can be done sequentially, i.e. in initial assembly work steps executed one after the other, or simultaneously, in a single initial assembly work step. The subsequent connection of the contact points 5 of the power electronic unit 4 to the connecting sections 12 of the (already clamped to the sockets 8) clamping elements 9 can in turn be done sequentially, i.e. in second assembly work steps executed one after the other, or simultaneously in a single second work step.

However, it would also be conceivable that at first the connection of the contact points 5 of the power electronic unit 4 to the connecting sections 12 of the clamping elements 9 would be done sequentially, i.e. in initial assembly work steps executed one after the other, or simultaneously, in a single initial assembly work step. The insertion of the clamping elements 9 already connected to the power electronic unit 4 into the sockets 8 could then be done in a subsequent single, second, assembly work step.

According to the preferred embodiment of the invention shown, the contact elements 3 are executed with an outer insulating layer 6, and the clamping elements 9 are executed as cutting and clamping elements 13, like those shown in detail in FIG. 2. At the same time, each of the cutting and clamping elements 13 in turn, of course, has a clamping section 10 executed as a cutting and clamping section 14, and a connecting section 12. When cutting and clamping elements 13 having the cutting and clamping sections 14 are inserted into the sockets 8, the insulating layer 6 of the respective enameled wire 3a is severed by blades 15 arranged on the cutting and clamping section 14, so that an electroconductive contact is created between the cutting and clamping section 14 of the cutting and clamping element 13 and the contact element 3. At the same time, as a result the contact element 3 is also clamped and fixed, guaranteeing a secure electrical contact. The cutting and clamping section 14 is of course electroconductively connected to the connecting section 12.

The individual steps for inserting the cutting and clamping element 13 into the socket 8 are shown in detail in FIGS. 2A and 2B; FIG. 3 shows a cutting and clamping element 13 in detail. First, the contact element 3 insulated with an insulating layer 6 is inserted into the socket 8, which can be done purely by machine and by automated means. The socket 8 therefore has an opening suitable for accommodating the contact element 3, for example an oblong slot 16 like the one shown in FIG. 2A. For example, the contact elements 3 can be bent in a suitable manner to carry out the assembly procedures according to the invention in a first work step prior to the insertion of the cutting and clamping elements 13 into the sockets 8, in order to be able to arrange the sockets 8 into the slots 16. In FIG. 1, the contact elements 3 are bent at a 90° angle, for example. Of course, other arrangements are conceivable, depending on the design of the sockets 8 and of the clamping elements 9.

As shown in FIG. 3, the cutting and clamping element 13 of the preferred embodiment has on the cutting and clamping section 14 two clamping parts 17 facing one another, each having a blade 15 for severing the insulating layer 6 of the enameled wire 3a, between which is arranged a guiding hole 19 to guide the enameled wire 3a.

The cutting and clamping element 13 is, as indicated by the arrow in FIG. 2A, inserted into a contact opening 18 of the socket 8 so that the contact element 3 already arranged in the slot 16 of the socket 8 is accommodated by the guiding hole 19 (see FIG. 2B, above). If the cutting and clamping element 13 (see the middle of FIGS. 2A and 2B) is inserted further into the contact opening 18, the insulating layer 6 of the enameled wire 3a is severed by means of the blades 15 arranged on the clamping parts 17. At the same time, the insulating layer 6 of the enameled wire 3a is severed in such a manner that an electroconductive connection is created between the conductive core of the contact element 3, i.e., for example, the strand of the enameled wire 3a, and the cutting and clamping element 13. Inserting the cutting and clamping element 13 up to the end of the contact opening 18, which preferably serves simultaneously as a physical stop for the cutting and clamping element 13, preferably elastically deforms the clamping parts 17 of the cutting and clamping section 14, which causes a mutual clamping force Fₖ to be exerted on the contact element 3 (see FIG. 3). This can guarantee an attachment of the contact element 3 to the cutting and clamping element 13 and thereby guarantee an electroconductive connection between contact element 3 and cutting and clamping element 13. In order to prevent loosening of the cutting and clamping element 13 from the socket 8 and thus prevent any resulting interruption of the electrical contact, an additional securing element (not shown) can be provided, for example on the socket 8 or on the transport segment 1. It would be conceivable, for example, that the cutting and clamping element 13 would snap into a suitable securing element upon reaching the end position, i.e. the stop, of the socket 8, or be secured from coming loose in another suitable manner.

In order to be able to insert the cutting and clamping element 13 into the socket 8 against the clamping force Fₖ requires, of course, a mounting force Fₘ lengthwise of the cutting and clamping element 13, as shown in FIG. 2A. Depending on the material and constructional design of the cutting and clamping element 13, the mounting force Fₘ required also varies. However, usually not only one drive coil 2 having two contact elements 3 is arranged on a transport segment 1, but rather a plurality of drive coils 2, each having two contact elements 3. Accordingly then, preferably a number of cutting and clamping elements 13, corresponding to the number of the contact elements 3, are provided to connect the contact points 5 of the power electronic unit 4 and/or the printed circuit board 4a to the contact elements 3 of the drive coils 2. In the case of the assembly procedure according to the invention, as was already described, all cutting and clamping elements 13 can be inserted simultaneously into the contact openings 18 of the corresponding sockets 8 in one assembly work step. This, of course, results in a much greater total required mounting force Fₘ, than when only one cutting and clamping element 13 is clamped. The total required mounting force results from the total number of cutting and clamping elements 13 simultaneously inserted into the sockets 8 where F_{mG}=ΣFₘᵢ (the index i stands for the number of cutting and clamping elements 13).

Generally, a printed circuit board 4a is made out of nonconductive and relatively brittle plastic, and therefore has only a limited capacity to withstand forces, which is something that should be kept in mind when carrying out the assembly procedure. If the cutting and clamping elements 13 are arranged first on the circuit board 4a, for example, and later inserted jointly in one work step into the sockets 8, the circuit board 4a should therefore be suitable for withstanding the total mounting force F_{mG} necessary to clamp all arranged cutting and clamping elements 13.

If the circuit board 4a cannot withstand the total mounting force F_{mG}, it is advantageous if first the cutting and clamping elements 13 are simultaneously (or sequentially) inserted into the sockets 8 in an initial work step by applying the total mounting force F_{mG} (or the individual mounting forces Fₘ,). In so doing, the insulating layers 6 of all contact elements 3 of all drive coils 2 arranged on the transport segment 1 are severed simultaneously and the contact elements 3, as already described in detail, are clamped into the sockets 8 by the existing clamping forces Fₖ while creating an electroconductive connection. This initial work step (or the initial work steps) is carried out by means of a suitable mounting device; however, said device is not the subject matter of the invention and therefore need not be further elaborated here.

After the cutting and clamping elements 13 are properly arranged in the sockets 8, the circuit board 4a can be connected to the transport segment 1 in the next work step. To that end, the contact points 5 of the circuit board 4a, preferably in turn simultaneously (or sequentially) are connected to the cutting and clamping elements 13 already clamped into the sockets 8 of the transport segment 1 by means of a suitable mounting device. Mounting devices are known in the prior art and the actual design of the mounting device is irrelevant and not part of the invention. It is also advantageous to execute the connecting section 12 of the clamping element 9 or of the cutting and clamping element 13 as a clip-connection section or as a solder-connection section, and to execute the corresponding contact point 5 of the circuit board 4a as a clip-contact point or solder-contact point. For example, in FIG. 3 the connecting section 12 of the clamping element 9 or of the cutting and clamping element 13 is executed as a clip-connection section. To connect the clamping element 9 to the circuit board 4a, the clip-connection section is inserted into the clip-contact point of the circuit board 4a that corresponds to it by the application of a press-in force. This creates an electroconductive connection between the clip-contact point of the circuit board 4a and the contact element 9 without soldering. Although other embodiments are conceivable, the important thing here is that as little force as possible has to be used to connect the circuit board 4a to the connecting sections 12 of the clamping elements 9 or cutting and clamping elements 13, so as not to damage the circuit board 4a. Clip connections have the advantage that a solder-free and consequently very quick mounting of the clamping elements 9 to the circuit board 4a is possible; however, press-in forces must be taken into account for the manufacture of the clip connection. Although a solder connection is somewhat more time-consuming compared to a clip-connection, it has the advantage that no press-in forces occur, which is why there is no mechanical stress placed on the power electronic unit 4 or circuit board 4a. For example, in FIG. 2 the connecting section 12 of the clamping element 9 or of the cutting and clamping element 13 is executed as a solder-connection section or as a so-called “solder lug.” To create an electroconductive connection between clamping element 9 and the circuit board 4a, the solder-connection section makes contact with and is soldered to a suitable corresponding solder-contact point of the circuit board 4a.

It is advantageous to arrange on the transport segment 1 fastening elements 20 to fasten the circuit board 4a to the transport segment 1 and to the fastening points 21 that interact with the circuit board 4a. Fastening elements 20 can be conventional screw connections, for example. As a result, the stress induced in particular by the weight of the circuit board 4a can be withstood better by the transport segment 1, and the clamping elements 9 can be relieved of the stress.

1. Assembly procedure for connecting at least one power electronic unit to a transport segment of a long-stator linear motor, wherein the transport segment comprises at least one drive coil with at least two contact elements, and the at least one power electronic unit comprises at least two contact points that correspond to the contact elements of the drive coil, wherein an electroconductive connection is created between the contact elements of the drive coil and the contact points of the at least one power electronic unit, wherein at least one socket is arranged on the transport segment to accommodate at least one contact element of the drive coil, the at least one contact element of the drive coil is arranged in the socket, at least one clamping element corresponding to the socket is inserted into the socket with a clamping section, wherein the contact element of the drive coil, while creating an electroconductive connection to the clamping section of the clamping element, is fixed into the socket by the clamping element, and wherein at least one contact point of the at least one power electronic unit, while creating an electroconductive connection, is connected directly to a connecting section of the clamping element, wherein first the contact element of the drive coil is arranged in the socket, then the clamping element is inserted into the socket with the clamping section, and then the contact point of the power electronic unit is connected to the connecting section of the clamping element by soldering or plugging in.

2. Assembly procedure according to claim 1, wherein at least two sockets for accommodating at least one contact element each are arranged on the transport segment, the at least two contact elements are arranged in the sockets, at least two clamping elements corresponding to the sockets, each having a clamping section, are inserted sequentially or simultaneously into the sockets, and wherein at least two contact points of the at least one power electronic unit are connected sequentially or simultaneously to the connecting sections of the clamping elements.

3. Assembly procedure according to claim 1, wherein the at least one contact element of the drive coil is executed as an electroconductive wire with an outer insulating layer, as a so-called “enameled” wire, and wherein the at least one clamping element is executed as a cutting and clamping element with a cutting and clamping section, wherein when the cutting and clamping element is inserted into the at least one socket, the outer insulating layer of the contact element of the drive coil is severed by the cutting and clamping section to create the electroconductive connection.

4. Assembly procedure according to claim 1, wherein the connecting section of the clamping element is executed as a clip-connection section, and the corresponding contact point of the power electronic unit is executed as a clip-contact point, wherein to connect the power electronic unit to the clamping element, the clip-connection section is inserted into the clip-contact point of the power electronic unit that corresponds to it by applying a press-in force.

5. Assembly procedure according to claim 1, wherein the at least one contact point of the power electronic unit is executed as an opening with a closed circumferential surface corresponding to the shape of the connecting section of the clamping element that penetrates the power electronic unit, and that when the power electronic unit is connected to the clamping element, the connecting section at least partially penetrates the opening and is completely enclosed by the closed circumferential surface.
